(19) United States
(12) Patent Application Publication
(10) Pub. No.: US 2025/0053314 A1
(43) Pub. Date: Feb. 13, 2025

(54) METHOD FOR CONTROLLER FLASH MEMORY MODULE AND ASSOCIATED FLASH MEMORY CONTROLLER AND MEMORY DEVICE

(71) Applicant: Silicon Motion, Inc., Hsinchu County (TW)

(72) Inventors: Kuan-Chieh Peng, Taoyuan City (TW); Tzu-Yi Yang, Hsinchu County (TW)

(73) Assignee: Silicon Motion, Inc., Hsinchu County (TW)

(21) Appl. No.: 18/676,488

(22) Filed: May 28, 2024

(30) Foreign Application Priority Data
Aug. 9, 2023 (TW) 112129891

(51) Int. Cl. G06F 3/06

(52) U.S. Cl. CPC G06F 3/0619; G06F 3/0659; G06F 3/0679

(57) ABSTRACT

The present invention provides a method for controlling a flash memory module. The method includes: after the flash memory module is powered on, determining whether the flash memory module encountered an abnormal power failure before the flash memory module is powered on; if the flash memory module encounters the abnormal power failure before the flash memory module is powered on, determining a last super block written by the flash memory module before powering on, where the super block comprises multiple first blocks respectively located in the multiple dies; for each first block in the super block, determining a last successfully read page of the first block; determining a data weak region of the super block according to the last successfully read pages of the first blocks in the super block; and moving data in the weak data region to other regions of the super block or to another super block.

### BACKGROUND OF THE INVENTION

### 1. Field of the Invention

The present invention relates to flash memory.

### 2. Description of the Prior Art

During the process of a flash memory controller writing data to a super block of a flash memory module, if an abnormal power-off occurs, such as power off recovery (POR) or sudden power off recovery (SPOR) occurs, the flash memory controller will determine whether it has encountered an abnormal power failure after the flash memory controller is powered on again. In the event of abnormal power failure, the flash memory controller determines which data in a super block is still valid, and performs a garbage collection operation on the super block to move the valid data to another block. However, since the super block includes multiple blocks, and the data writing progress of each block is different, how to efficiently determine the valid data in the super block is an important issue.

### SUMMARY OF THE INVENTION

Therefore, one of the objects of the present invention is to provide a control method for a memory device, which can efficiently and accurately determine which data in the super block is available for use when the memory device is powered on after the memory device is powered off abnormally, and the super block can be used for continued writing of data, to solve the above-mentioned problems.

According to one embodiment of the present invention, a method for controlling a flash memory module is disclosed, wherein the flash memory module comprises multiple dies, each die comprises multiple blocks, and each block comprises multiple pages. The method comprises: after the flash memory module is powered on, determining whether the flash memory module encountered an abnormal power failure before the flash memory module is powered on; if the flash memory module encounters the abnormal power failure before the flash memory module is powered on, determining a last super block written by the flash memory module before powering on, where the super block comprises multiple first blocks respectively located in the multiple dies; for each first block in the super block, determining a last successfully read page of the first block; determining a data weak region of the super block according to the last successfully read pages of the first blocks in the super block; and moving data in the weak data region to other regions of the super block or to another super block.

According to one embodiment of the present invention, a flash memory controller is disclosed, wherein the flash memory controller is configured to access a flash memory module, the flash memory module comprises multiple dies, each die comprises multiple blocks, and each block comprises multiple pages. The flash memory controller comprises a read only memory configured to store a program code, and a microprocessor configured to execute the program code to a control access of the flash memory module. The microprocessor is configured to perform the steps of: after the flash memory module is powered on, determining whether the flash memory module encountered an abnormal power failure before the flash memory module is powered on; if the flash memory module encounters the abnormal power failure before the flash memory module is powered on, determining a last super block written by the flash memory module before powering on, where the super block comprises multiple first blocks respectively located in the multiple dies; for each first block in the super block, determining a last successfully read page of the first block; determining a data weak region of the super block according to the last successfully read pages of the first blocks in the super block; and moving data in the weak data region to other regions of the super block or to another super block.

According to one embodiment of the present invention, a memory device comprising a flash memory module and a flash memory controller is disclosed. The flash memory module comprises multiple dies, each die comprises multiple blocks, and each block comprises multiple pages. The flash memory controller is configured to perform the steps of: after the flash memory module is powered on, determining whether the flash memory module encountered an abnormal power failure before the flash memory module is powered on; if the flash memory module encounters the abnormal power failure before the flash memory module is powered on, determining a last super block written by the flash memory module before powering on, where the super block comprises multiple first blocks respectively located in the multiple dies; for each first block in the super block, determining a last successfully read page of the first block; determining a data weak region of the super block according to the last successfully read pages of the first blocks in the super block; and moving data in the weak data region to other regions of the super block or to another super block.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a memory device according to one embodiment of the present invention.

FIG. 2 is a diagram illustrating a super block according to one embodiment of the present invention.

FIG. 3 is a diagram showing multiple pages of a block.

FIG. 4 is a diagram showing that the writing speeds of the blocks in a super block are different.

FIG. 5 is a flowchart of a control method of the memory device according to one embodiment of the present invention.

FIG. 6 is a flowchart of using a binary search method to search the last page with data written in each block.

FIG. 7 is a diagram of determining the last page that can be successfully read in each block of the super block.

FIG. 8 is a diagram of determining a data weak region and an invalid region of the super block.

### DETAILED DESCRIPTION

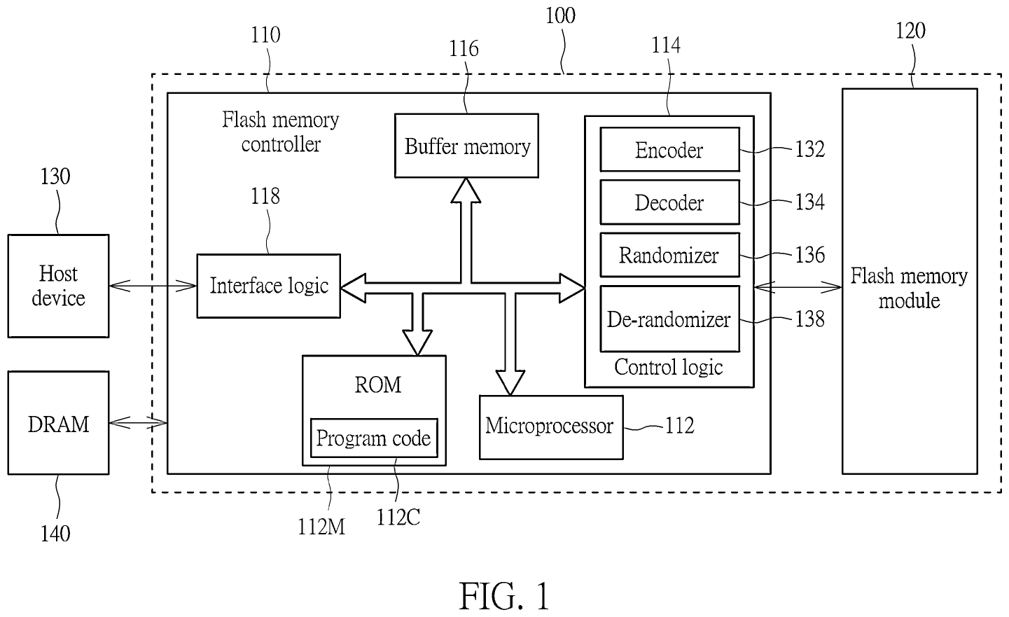

FIG. 1 is a diagram illustrating a memory device 100 according to an embodiment of the present invention. The memory device 100 includes a flash memory module 120 and a flash memory controller 110, wherein the flash memory controller 110 is arranged to access the flash memory module 120. The flash memory controller 110 includes a microprocessor 112, a read only memory (ROM) 112M, a control logic 114, a buffer memory 116 and an interface logic 118. The ROM 112M is arranged to store a program code 112C, and the microprocessor 112 is arranged to execute the program code 112C to control access of the flash memory module 120. The control logic 114 includes an encoder 132, a decoder 134, a randomizer 136 and a de-randomizer 138. The encoder 132 is arranged to encode data that is written into the flash memory module 120 to generate a corresponding parity (also known as an error correction code (ECC)), and the decoder 134 is arranged to decode data that is read from the flash memory module 120. The randomizer 136 is used to randomize the data written to the flash memory module 120, and the de-randomizer 138 is used to de-randomize the data read from the flash memory module 120.

In a general situation, the flash memory module 120 includes a plurality of flash memory chips, and each flash memory chip includes a plurality of blocks. A controller (e.g. the flash memory controller 110 that executes the program code 112C through the microprocessor 112) may copy, erase, and merge data for the flash memory module 120 with a block as a unit. In addition, a block can record a specific number of pages, wherein the controller (e.g. the flash memory controller 110 that executes the program code 112C through the microprocessor 112) may perform a data write operation upon the flash memory module 120 with a page as a unit. In other words, a block is the smallest erase unit in the flash memory module 120, and a page is the smallest write unit in the flash memory module 120.

In practice, the flash memory controller 110 that executes the program code 112C through the microprocessor 112 may utilize its own internal components to perform many control operations. For example, the flash memory controller 122 utilizes the control logic 114 to control access of the flash memory module 120 (more particularly, access at least one block or at least one page), utilizes the buffer memory 116 and/or a DRAM 140 to perform a required buffering operation, and utilizes the interface logic 118 to communicate with a host device 130.

In one embodiment, the memory device 100 may be a portable memory device such as a memory card which conforms to one of the SD/MMC, CF, MS and XD specifications, and the host device 130 is an electronic device able to be connected to the memory device 100, such as a cellphone, a laptop, a desktop computer, etc. In another embodiment, the memory device 100 can be a solid state drive (SSD) or an embedded storage device conforming to the universal flash storage (UFS) or embedded multi-media card (EMMC) specifications, and can be arranged in an electronic device. For example, the memory device 100 can be arranged in a cellphone, a watch, a portable medical testing device (e.g. a medical wristband), a laptop, or a desktop computer. In this case, the host device 130 can be a processor of the electronic device.

In this embodiment, the flash memory module 120 is a three-dimensional (3D) NAND-type flash memory, in which each block is composed of multiple word lines, multiple bit lines and multiple memory cells. Since the 3D NAND flash memory architecture is well known to those with ordinary knowledge in the art, no further explanation is given in the specification.

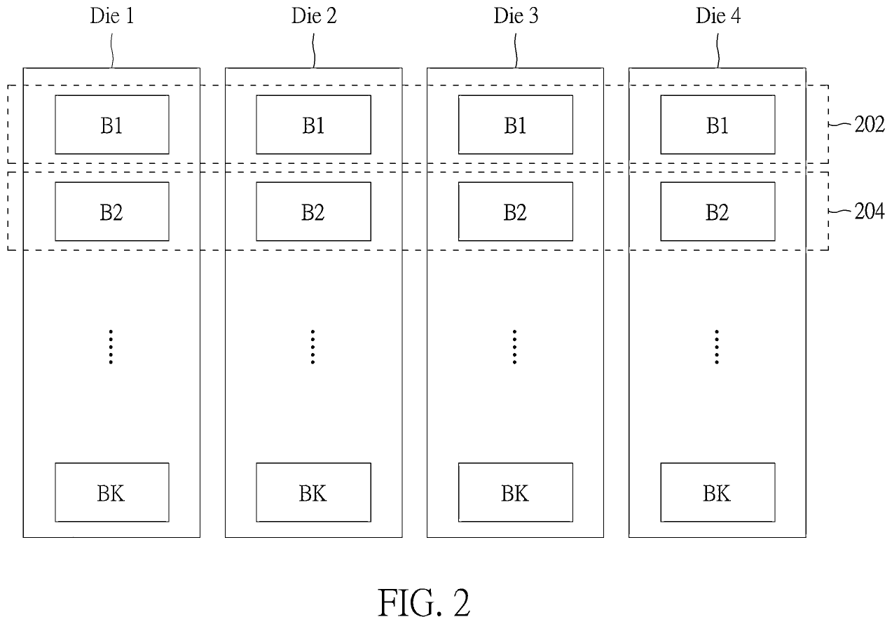

FIG. 2 is a diagram of a super block according to one embodiment of the present invention. As shown in FIG. 2, it is assumed that the flash memory module 120 includes four dies (die 1 to die 4), and each die includes multiple blocks B1-BK. At this time, the microprocessor 112 can configure blocks belonging to different data planes or different dies within the flash memory module 120 as a super block to facilitate management of data access. In this embodiment, there is only one data plane in one die, but the invention is not limited to this. As shown in FIG. 2, die 1 to die 4 respectively include blocks B1-BK, and the microprocessor 112 can configure the block B1 of each die as a super block 202, and configure the block B2 of each die as a super block 204, and so on. The operation of the flash memory controller 110 in accessing the super blocks 202 and 204 is similar to accessing the general blocks. For example, the super block 202 itself is an erase unit. That is, although the four blocks B1 included in the super block 202 can be erased separately, the flash memory controller 110 will definitely erase the four blocks B1 together.

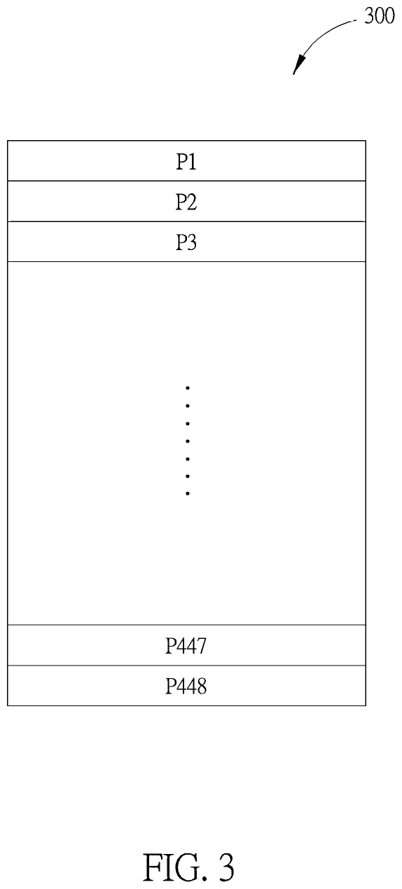

FIG. 3 is a diagram illustrating a block 300, wherein the block 300 can be any one of the blocks B1-BK shown in FIG. 2, and the block 300 includes multiple pages, such as 448 pages in the figure. When writing data to the super block 202, the first page P1 of the block B1 of the die 1, the first page P1 of the block B1 of the die 2, the first page P1 of the die 3 and the first page P1 of the block B1 of the die 4 can be sequentially written. Then, the data is written into the second page P2 of the block B1 of die 1, the second page P2 of the block B1 of the die 2, . . . , and so on. In other words, the flash memory controller 110 writes data to the first page P1 of each block B1 in the super block 202, and then writes data to the second page P2 of each block B1 in the super block 202. The super block is a collection block logically set by the flash memory controller 110 for the convenience of managing the flash memory module 120, not a physical collection block. In addition, when performing garbage collection, calculating the effective pages of a block, and calculating the length of writing a block, calculations can also be performed in units of super blocks.

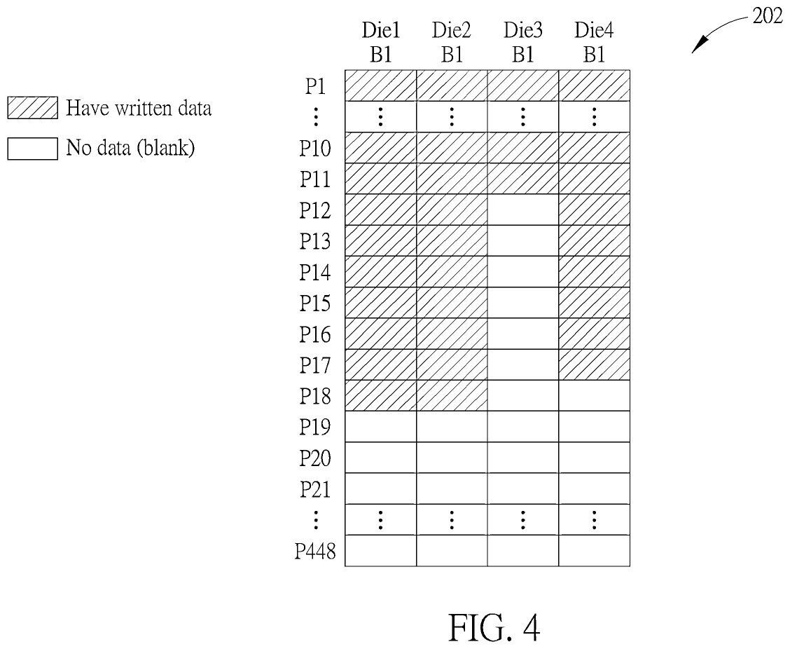

In one embodiment, the flash memory controller 110 may have multiple buffers for temporarily storing data to be written to multiple dies (for example, die 1 to die 4 in FIG. 2), wherein these buffers do not need to be used in sequence, and each die in the flash memory module 120 has its own back-end hardware so that the flash memory module 120 can write data into multiple dies in parallel. However, in some embodiments, the small differences in the writing speed of each die will continue to accumulate, resulting in a large difference in the data writing of the multiple dies. For example, referring to FIG. 4, the flash memory controller 110 sequentially writes data to the first pages P1 of die 1 to die 4, the second pages P2 of die 1 to die 4, the third pages P1 of die 1 to die 4, . . . and so on. Due to the differences in the manufacturing process of each die, the data writing speed of die 3 will be slower than that of other die, for example, when die 1 and die 2 have been written to the page P18, die 3 has only been written to the page P11. It should be noted that, at this time, the microprocessor 112 has already generated data to be written to the pages P12-P18 of die 3, and these data are temporarily stored in the control logic 114 or a buffer of the flash memory module 120.

However, if an abnormal power failure occurs when the data shown in FIG. 4 is written to the super block 202, such as a SPOR, the flash memory controller 110 will read the contents of the super block 202 to determine the status of the super block 202 after the memory device 100 is powered on, so as to determine an appropriate processing method. This embodiment provides a control method after the memory device 100 is powered on, which can efficiently and accurately determine which data in the super block 202 can be used, and continue to write data into the super block 202, to optimize the use of super block 202.

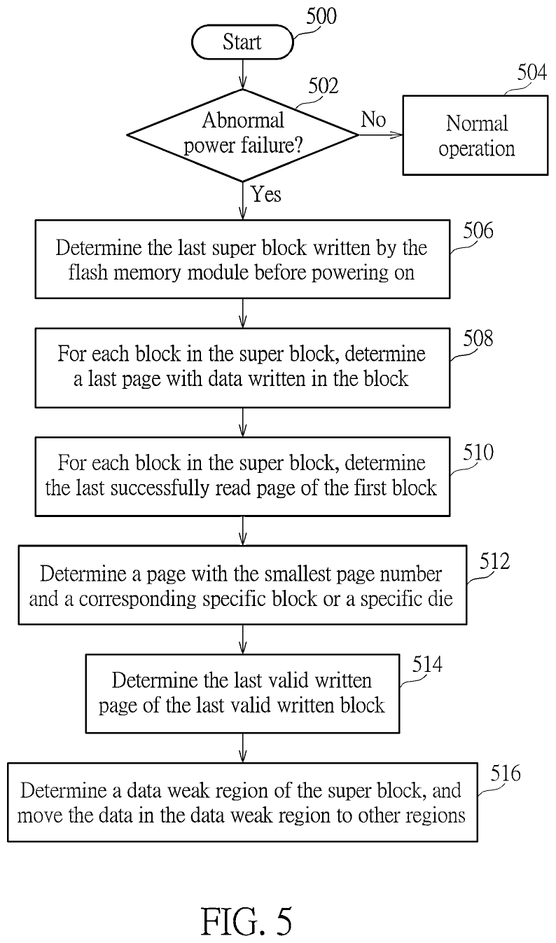

FIG. 5 is a flowchart of a control method of the memory device 100 according to one embodiment of the present invention. In Step 500, the flow starts, and the memory device 100 has been powered on and initialized. In Step 502, the flash memory controller 110 determines whether an abnormal power failure occurs before the memory device 100 is powered on, if yes, the flow enters Step 506; and if not, the flow enters Step 504. In one embodiment, when the memory device 100 is shut down/powered off normally, the flash memory controller 110 will store multiple temporary tables and data stored in the buffer memory 116 to the flash memory module 120, wherein the stored data includes a flag used to indicate whether the memory device 100 is powered off normally. Therefore, after powering on, the flash memory controller 110 can determine whether the memory device 100 has an abnormal power failure before by reading the above-mentioned tag stored at a specific address in the flash memory module 120. For example, when the above tag is not set correctly, it is determined that an abnormal power failure has been encountered before.

In Step 504, since the memory device 100 did not encounter an abnormal power failure before powering on, the flash memory controller 110 begins to operate normally, such as writing data from the host device 130 to the flash memory module 120, or performs a garbage collection operation on the flash memory module 120, etc., that is, the flash memory controller 110 will not execute Step 506-Step 516 in FIG. 4.

In Step 506, the flash memory controller 110 determines the last super block written by the flash memory module 120 before powering on. For example, the flash memory controller 110 may search for the super block in the active state recorded in the flash memory module 120 as the last super block written before powering on. In the following embodiments, the super block 202 shown in FIG. 4 is used as an illustration.

In Step 508, for each block in the super block, such as block B1 from die 1 to die 4 in the super block 202, the flash memory controller 110 uses a binary search method or any other suitable methods to search for the last page in each block that has data written to it. Taking FIG. 4 as an example, the flash memory controller 110 determines the page P18 of the block B1 of die 1, the page P18 of the block B1 of die 2, the page P11 of the block B1 of die 3, and the page P17 of the block B1 of die 4.

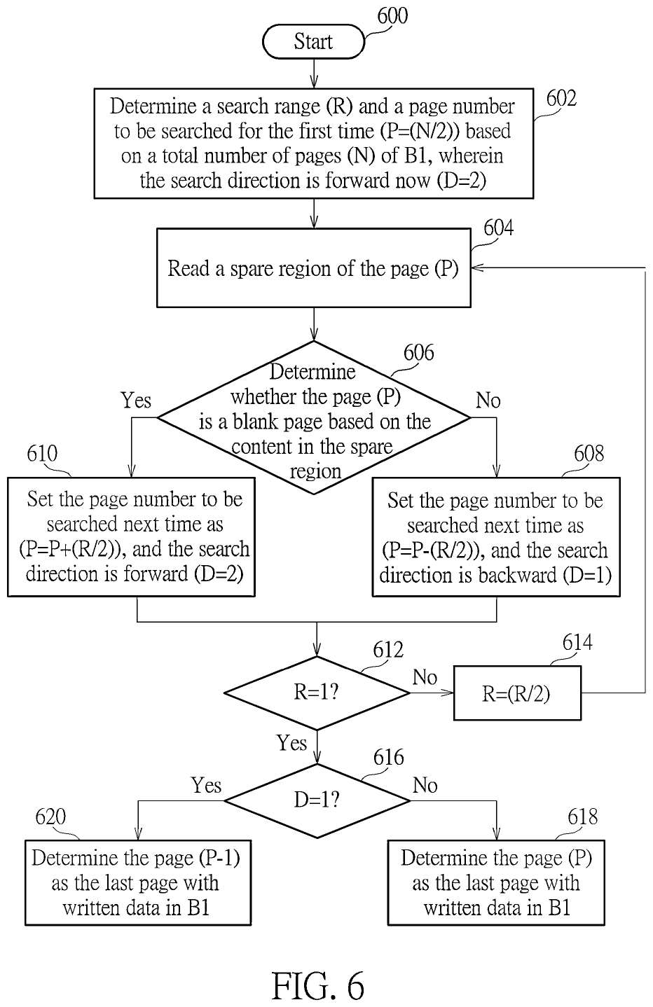

FIG. 6 is a flowchart of using a binary search method to search the last page with data written in each block B1. The flow is described as follows.

Step 600: the flow starts.

Step 602: determine a search range (R) and a page number to be searched for the first time (P=(N/2)) based on a total number of pages (N) in the block B1, wherein the search direction is forward now (D=2, that is, the direction in which the page number increases).

Step 604: read a spare region of the page (P).

Step 606: determine whether the page (P) is a blank page based on the content in the spare region, for example, determine whether the page (P) is a blank page based on whether the metadata is recorded in the spare region. If it is determined that the page (P) is a blank page, the flow enters Step 608; and if it is determined that the page (P) is not a blank page, the flow enters Step 610.

Step 608: set the page number to be searched next time as (P=P−(R/2)), and the search direction at this time is backward (D=1, the direction in which the page number decreases).

Step 610: set the page number to be searched next time as (P=P+(R/2)), and the search direction at this time is forward (D=2).

Step 612: determine whether the search range (R) is 1. If not, the flow enters Step 614; and if yes, the flow enters Step 616.

Step 614: halve the search range (R=(R/2)), and the flow goes back to Step 604.

Step 616: determine whether the search direction is backward (D=1). If not, the flow enters Step 618; and if yes, the flow enters Step 620.

Step 618: determine the page (P) as the last page with written data in the block B1.

Step 620: determine the page (P-1) as the last page with written data in the block B1.

It should be noted that the detailed steps shown in FIG. 6 are only used as examples and are not limitations of the present invention.

In one embodiment, since each block in the super block 202 can operate in parallel, the flash memory controller 110 can use interleave or multi-channel operation to read data from multiple blocks simultaneously to speed up the execution of the above binary search method or other search methods.

In Step 510, for each block, the flash memory controller 110 reads backward sequentially from the last page with written data until the read data can be successfully decoded by the decoder 134, that is, the decoder 134 can successfully use the error correction code of the read data to complete the decoding operation, to determine the last successfully read page of each block in the super block 202.

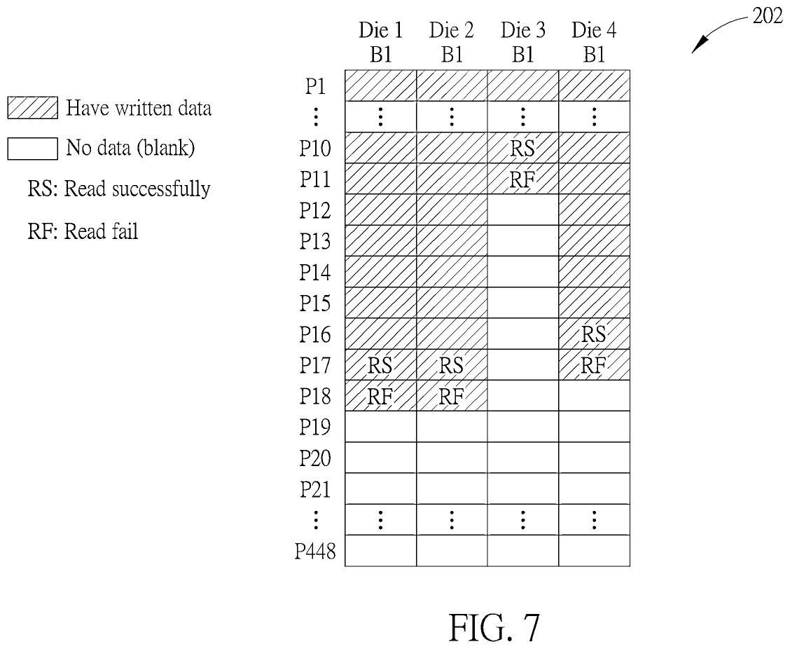

Taking FIG. 7 as an example, the decoder 134 cannot successfully decode the data of page P18 of the block B1 of die 1, but can successfully decode the data of page P17 of the block B1 of die 1, so the flash memory controller 110 determines that the last successfully read page in block B1 of die 1 is P17. Similarly, the flash memory controller 110 determines that the last successfully read page in block B1 of die 2 is P17, the last successfully read page in block B1 of die 3 is P10, and the last successfully read page in block B1 of die 4 is P16.

In Step 512, based on the last successfully read pages of each block in the super block 202, the flash memory controller 110 determines a page with the smallest page number and a corresponding specific block or a specific die. Taking FIG. 7 as an example, the specific block is block B1 of die 3, the specific die is die 3, and the page with the smallest page number is P10.

In Step 514, the flash memory controller 110 determines the last valid written page of the last valid written block based on the specific block and the page with the smallest page number determined in Step 512. In one embodiment, if the number of the specific block or the number of the die to which the specific block belongs is N, where N is greater than 1, the number of the page with the smallest page number is M, then the number of the die to which a valid written block belongs is “N−1”, and the last valid written page is “M+1”. Taking FIG. 7 as an example, the specific die determined in Step 512 is die 3, and the page with the smallest page number is P10, then the last valid written page in the super block 202 is page P11 of the block B1 of die 2. In addition, if the specific block belongs to die 1, the die to which the last valid written block belongs is the die with the largest number (for example, die 4 in FIG. 7), and the last valid written page is “M”.

In Step 516, the flash memory controller 110 determines a data weak region and an invalid region of the super block 202 according to the last valid written block and the last valid rewritten page in the super block 202 determined in Step 514, and the flash memory controller 110 moves the data in the data weak region to other regions in the super block 202 or to other super blocks.

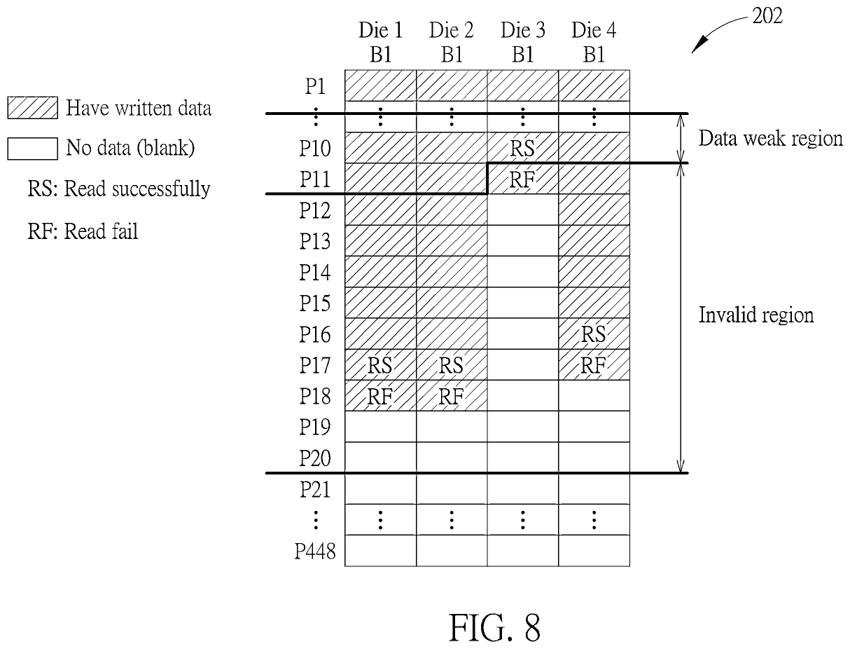

Referring to FIG. 8, the flash memory controller 110 can push back the last valid written page in the super block 202 several pages (for example, corresponding to one or two word lines) to determine the data weak region. For example, the data weak region may include page P5-P10 of block B1 of die 1 to die 4, and page P11 of the block B1 of die 1 and die 2. In addition, the flash memory controller 110 can determine the following pages (for example, corresponding to several pages of two word lines) to determine the invalid region. For example, the invalid region may include page P11 of the block B1 of die 3 and die 4, and pages P12-P20 of the blocks B1 of die 1 to die 4.

In one embodiment, since the data weak region of the super block 202 can be regarded as a region with unstable data, if the space behind the invalid region in the super block 202 is sufficient, the flash memory controller 110 can copy the data of the data weak region to the space after the invalid region in the super block 202, such as page P21 of the block B1 of die 3 and die 4 and subsequent pages. If the space after the invalid region in the super block 202 is insufficient, the flash memory controller 110 copies the data in the weak region to another super block.

In one embodiment, the flash memory controller 110 can perform double programming on the invalid region of the super block 202, that is, write invalid data or redundant data into the invalid region in order to stabilize the super block 202.

As described in the above embodiments, the present invention can efficiently and accurately determine which data in the super block 202 is valid can continue to be used, and move data of the data weak region of the super block 202 to other pages to ensure the reliability of the data.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for controlling a flash memory module, wherein the flash memory module comprises multiple dies, each die comprises multiple blocks, and each block comprises multiple pages, and the method comprises:
after the flash memory module is powered on, determining whether the flash memory module encountered an abnormal power failure before the flash memory module is powered on;
if the flash memory module encounters the abnormal power failure before the flash memory module is powered on, determining a last super block written by the flash memory module before powering on, where the super block comprises multiple first blocks respectively located in the multiple dies;
for each first block in the super block, determining a last successfully read page of the first block;
determining a data weak region of the super block according to the last successfully read pages of the first blocks in the super block; and
moving data in the weak data region to other regions of the super block or to another super block.

2. The method of claim 1, wherein the step of determining the data weak region of the super block according to the last successfully read pages of the first blocks in the super block comprises:
determining a page with a smallest page number and a corresponding specific first block according to the last successfully read pages of the first blocks in the super block;
determining a last valid written page of a last valid written first block in the super block according to the page with the smallest page number and the corresponding specific first block; and
determining the data weak region according to the last valid written page of the last valid written first block in the super block.

3. The method of claim 2, wherein the step of determining the last valid written page of the last valid written first block in the super block according to the page with the smallest page number and the corresponding specific first block comprises:
if a number of the specific block or a number of the die to which the specific block belongs is N, where N is greater than 1, a number of the page with the smallest page number is M, determining the last valid written block having the a number “N−1”, and determining the last valid written page having a number “M+1”; and
if the specific block belongs to a first die, the number of the page with the smallest page number is M, determining the last valid written block having a largest number, and determining the last valid written page having the number “M”.

4. The method of claim 1, further comprising:
for each first block in the super block, determining a last page with data written in the first block; and
the step of determining the last successfully read page of the first block comprises:
reading backward from the last page with data written in each first block to determine the last successfully read page of each first block in the super block.

5. The method of claim 4, wherein the step of determining the last page with data written in the first block comprises:
using a binary search method and simultaneously read data from the multiple first blocks in the super block through an interleave or a multi-channel operation to determine the last page with data written in each first block.

6. A flash memory controller, wherein the flash memory controller is configured to access a flash memory module, the flash memory module comprises multiple dies, each die comprises multiple blocks, and each block comprises multiple pages; and the flash memory controller comprises:
a read only memory, configured to store a program code; and
a microprocessor, configured to execute the program code to a control access of the flash memory module;
wherein the microprocessor is configured to perform the steps of:
after the flash memory module is powered on, determining whether the flash memory module encountered an abnormal power failure before the flash memory module is powered on;
if the flash memory module encounters the abnormal power failure before the flash memory module is powered on, determining a last super block written by the flash memory module before powering on, where the super block comprises multiple first blocks respectively located in the multiple dies;
for each first block in the super block, determining a last successfully read page of the first block;
determining a data weak region of the super block according to the last successfully read pages of the first blocks in the super block; and
moving data in the weak data region to other regions of the super block or to another super block.

7. The flash memory controller of claim 6, wherein the step of determining the data weak region of the super block according to the last successfully read pages of the first blocks in the super block comprises:
determining a page with a smallest page number and a corresponding specific first block according to the last successfully read pages of the first blocks in the super block;
determining a last valid written page of a last valid written first block in the super block according to the page with the smallest page number and the corresponding specific first block; and
determining the data weak region according to the last valid written page of the last valid written first block in the super block.

8. The flash memory controller of claim 7, wherein the step of determining the last valid written page of the last valid written first block in the super block according to the page with the smallest page number and the corresponding specific first block comprises:
if a number of the specific block or a number of the die to which the specific block belongs is N, where N is greater than 1, a number of the page with the smallest page number is M, determining the last valid written block having the a number “N−1”, and determining the last valid written page having a number “M+1”; and
if the specific block belongs to a first die, the number of the page with the smallest page number is M, determining the last valid written block having a largest number, and determining the last valid written page having the number “M”.

9. The flash memory controller of claim 6, further comprising:
for each first block in the super block, determining a last page with data written in the first block; and
the step of determining the last successfully read page of the first block comprises:
reading backward from the last page with data written in each first block to determine the last successfully read page of each first block in the super block.

10. The flash memory controller of claim 9, wherein the step of determining the last page with data written in the first block comprises:
using a binary search method and simultaneously read data from the multiple first blocks in the super block through an interleave or a multi-channel operation to determine the last page with data written in each first block.

11. A memory device, comprising:
a flash memory module, wherein the flash memory module comprises multiple dies, each die comprises multiple blocks, and each block comprises multiple pages; and
a flash memory controller, configured to access the flash memory module;
wherein the flash memory controller is configured to perform the steps of:
after the flash memory module is powered on, determining whether the flash memory module encountered an abnormal power failure before the flash memory module is powered on;
if the flash memory module encounters the abnormal power failure before the flash memory module is powered on, determining a last super block written by the flash memory module before powering on, where the super block comprises multiple first blocks respectively located in the multiple dies;
for each first block in the super block, determining a last successfully read page of the first block;
determining a data weak region of the super block according to the last successfully read pages of the first blocks in the super block; and
moving data in the weak data region to other regions of the super block or to another super block.

12. The memory device of claim 11, wherein the step of determining the data weak region of the super block according to the last successfully read pages of the first blocks in the super block comprises:
determining a page with a smallest page number and a corresponding specific first block according to the last successfully read pages of the first blocks in the super block;
determining a last valid written page of a last valid written first block in the super block according to the page with the smallest page number and the corresponding specific first block; and
determining the data weak region according to the last valid written page of the last valid written first block in the super block.

13. The memory device of claim 12, wherein the step of determining the last valid written page of the last valid written first block in the super block according to the page with the smallest page number and the corresponding specific first block comprises:
if a number of the specific block or a number of the die to which the specific block belongs is N, where N is greater than 1, a number of the page with the smallest page number is M, determining the last valid written block having the a number “N−1”, and determining the last valid written page having a number “M+1”; and
if the specific block belongs to a first die, the number of the page with the smallest page number is M, determining the last valid written block having a largest number, and determining the last valid written page having the number “M”.

14. The memory device of claim 11, further comprising:
for each first block in the super block, determining a last page with data written in the first block; and
the step of determining the last successfully read page of the first block comprises:
reading backward from the last page with data written in each first block to determine the last successfully read page of each first block in the super block.

15. The memory device of claim 14, wherein the step of determining the last page with data written in the first block comprises: using a binary search method and simultaneously read data from the multiple first blocks in the super block through an interleave or a multi-channel operation to determine the last page with data written in each first block.
